(19) United States
(12) Patent Application Publication
(10) Pub. No.: US 2005/0000217 A1
(43) Pub. Date: Jan. 6, 2005

(54) Method for operating an internal combustion engine

(76) Inventors: Michael Nau, Dornhan/Aischfeld (DE); Andreas Kufferath, Markgroeningen (DE); Tilo Landenfeld, Vaihingen/Enz (DE)

Correspondence Address: KENYON & KENYON, ONE BROADWAY, NEW YORK, NY, 10004, US

(21) Appl. No.: 10/841,284

(22) Filed: May 6, 2004

(30) Foreign Application Priority Data
May 19, 2003 (DE) 103 22 481.5

(51) Int. Cl. F02B 37/04

(52) U.S. Cl. 60/612; 123/295; 123/565; 123/562

(57) ABSTRACT

A method for operating an internal combustion engine using an electrically operated air compressor that allows for heating up an exhaust-gas treatment device more rapidly. The electrically operated air compressor is activated during a starting process of the internal combustion engine.

### FIELD OF THE INVENTION

The present invention relates to a method for operating an internal combustion engine.

### BACKGROUND INFORMATION

An internal combustion engine may be operated using an electrically operated air compressor.

Also, various methods may be used to rapidly heat up a catalytic-converter system to its operating temperature, in order to reduce the emission of pollutants after the start when using a gasoline engine. A distinction may be made between methods which “primarily” provide chemical energy, e.g. in the form of a rich exhaust gas in combination with secondary air, and methods which increase the sensible heat in the exhaust gas, for example, by retarding the ignition angle.

In the case of retarding the ignition angle, which corresponds to a deterioration in the mechanical efficiency of the engine, the air-mass flow supplied to the engine is increased in conjunction with an adjustment of the fuel-mass flow, and the ignition angle is adjusted as far as possible or useful in the “retard” direction. The increase in the supplied air-mass flow is ensured by corresponding adjustment of the throttle valve. This measure increases the exhaust-gas-mass flow and the exhaust-gas temperature, while the engine torque remains unchanged. This leads to a rise in the exhaust-gas enthalpy flow, and therefore to rapid heating of the catalytic converter.

### SUMMARY OF THE INVENTION

In contrast, with the exemplary method of the present invention, the electrically operated air compressor used in the operation of the internal combustion engine is activated during a starting process of the internal combustion engine. In this way, the air-mass flow supplied to the engine is even further increased, so that the supercharging further raises the exhaust-gas enthalpy flow. The temperature rise of an exhaust-gas treatment device such as a catalytic converter may therefore be additionally accelerated. The emission of pollutants after the start of the internal combustion engine may thus be further reduced.

The electrically operated air compressor may be triggered as a function of a heating power necessary for setting a predefined operating temperature of the exhaust-gas treatment device. In this manner, the operation of the electrically operated air compressor may be adapted particularly well to the necessary heat-up operation for the exhaust-gas treatment device, and unnecessary operation of the electrically operated air compressor may be avoided.

The electrically operated air compressor may be deactivated when a predefined amount of heat has been delivered to the exhaust-gas treatment device. In this way, unnecessary operation of the electrically operated air compressor is avoided and energy is saved.

The electrically operated air compressor may be operated with at least one further air compressor, especially an exhaust-gas turbocharger, which may be in positive feedback. In this way, the air-mass flow supplied to the engine may be increased even more, so that the supercharging further raises the exhaust-gas enthalpy flow. The temperature rise of the exhaust-gas treatment device may therefore be additionally accelerated. The emission of pollutants after the start of the engine may thus be further reduced.

The electrically operated air compressor may be at least partially deactivated when the further air compressor is used. In this way, unnecessary operation of the electrically operated air compressor is likewise prevented and energy is saved.

A direct fuel injection may be performed and if fuel is injected at least partially during a compression phase, which may be according to a homogeneous-split operation. This allows extremely retarded moments of ignition, and therefore the air-mass flow supplied to the engine may be further increased, so that the supercharging further raises the exhaust-gas enthalpy flow. The temperature rise of the exhaust-gas treatment device may therefore be additionally accelerated. The emission of pollutants after the start of the engine may thus be further reduced.

The electrically operated air compressor may be deactivated as a function of a required load or a required operating point. This ensures that the operation of the electrically operated air compressor for heating up the exhaust-gas treatment device is not at the expense of safety-critical demands on the operation of the internal combustion engine.

### BRIEF DESCRIPTION OF THE DRAWINGS

FIG. 1 shows a schematic view of an internal combustion engine.

FIG. 2 shows a function chart for illustrating a functioning mode of the exemplary method according to the present invention.

FIG. 3 shows a flowchart for illustrating an exemplary sequence of the method according to the present invention.

### DETAILED DESCRIPTION

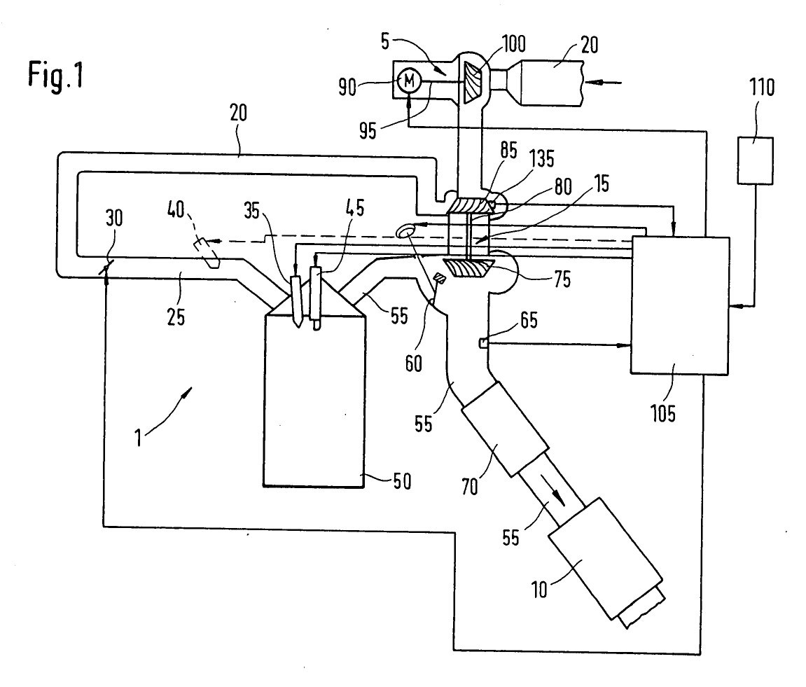

In FIG. 1, numeral 1 designates an internal combustion engine, for example, of a motor vehicle. Internal combustion engine 1 includes a combustion engine 50 which, for example, may take the form of a gasoline engine. Fresh air is supplied in the arrow direction via an air feed 20 to a combustion chamber (not shown in FIG. 1 for reasons of clarity) of combustion engine 50. Positioned in air feed 20 is a first air compressor 100 that is electrically driven by an electric motor 90 via a first shaft 95. In this example, first air compressor 100, first shaft 95 and electric motor 90 form an electric air compressor 5, also designated in the following as electric auxiliary air compressor.

In addition to electric auxiliary air compressor 5, as shown in FIG. 1, a second air compressor 85 may be positioned in air feed 20 in series with first air compressor 100. Second air compressor 85 is merely optionally provided. It is driven by a turbine 75 in an exhaust branch 55 of combustion engine 50 via a shaft 80. In this exemplary embodiment, second air compressor 85, second shaft 80 and turbine 75 form an exhaust-gas turbocharger 15. Alternatively, second air compressor 85 could also be driven by a supercharger that may be actuated via a crankshaft (not shown in FIG. 1) of combustion engine 50, and therefore would withdraw mechanical energy from combustion engine 50. In the following, however, by way of example, it shall be assumed that, as shown in FIG. 1, second air compressor 85 is part of exhaust-gas turbocharger 15 and is driven by it.

Downstream of second air compressor 85 in the direction of flow in air feed 20 is a throttle valve 30, via whose position the quantity of air-mass flow supplied to combustion engine 50 may be varied. The region of air feed 20 between throttle valve 30 and combustion engine 50 is also referred to as the intake manifold and is designated by reference numeral 25. The air is supplied in the combustion chamber of combustion engine 50 via an intake valve which, for the sake of clarity, is likewise not shown in FIG. 1. Fuel may be fed into the combustion chamber of combustion engine 50 either directly via a first fuel injector 35 or, alternatively, indirectly via a second fuel injector 40, represented by a dotted line in FIG. 1, by way of intake manifold 25. The air/fuel mixture in the combustion chamber of combustion engine 50 is ignited by a spark plug 45. The exhaust gas formed during the combustion of the air/fuel mixture in the combustion chamber of combustion engine 50 is expelled via an exhaust valve (not shown in FIG. 1) of the combustion chamber of combustion engine 50 into exhaust branch 55. Turbine 75 in exhaust branch 55 may be bypassed via a waste gate. The flow direction of the exhaust gas in exhaust branch 55 is likewise designated in FIG. 1 by an arrow.

Positioned downstream of turbine 75 in exhaust branch 55 in the direction of flow is a temperature sensor 65 which measures the temperature of the exhaust gas. Downstream of temperature sensor 65 in the direction of flow in exhaust branch 55 is a primary (starter) catalytic converter 70. Downstream of primary catalytic converter 70 in exhaust branch 55 in the direction of flow is a main catalytic converter 10. Primary catalytic converter 70 and main catalytic converter 10 together form an exhaust-gas treatment device. Internal combustion engine 1 also includes an engine management 105 which receives the measurement signal of temperature sensor 65. Also represented in FIG. 1 by way of example with reference numeral 110 is an electronic accelerator pedal, via whose actuation a driver's desired torque may be specified and supplied to engine management 105.

Additionally or alternatively, further torque demands, e.g. from a traction control system, an antilock braking system, a cruise control, a surge-damping function, etc., may be supplied to engine management 105. On its part, engine management 105 triggers throttle valve 30 for adjusting the air feed to the combustion chamber of combustion engine 50. Engine management 105 also controls the start of injection and the injection duration of first fuel injector 35 or, alternatively, of second fuel injector 40. Furthermore, engine management 105 triggers the moment of ignition of spark plug 45. Engine management 105 also controls electric motor 90 for adjusting a desired speed of electric auxiliary air compressor 5. In a speed sensor 135 in the region of second air compressor 85, a speed of exhaust-gas turbocharger 15 is supplied to engine management 105. Moreover, engine management 105 controls the position of waste gate 60.

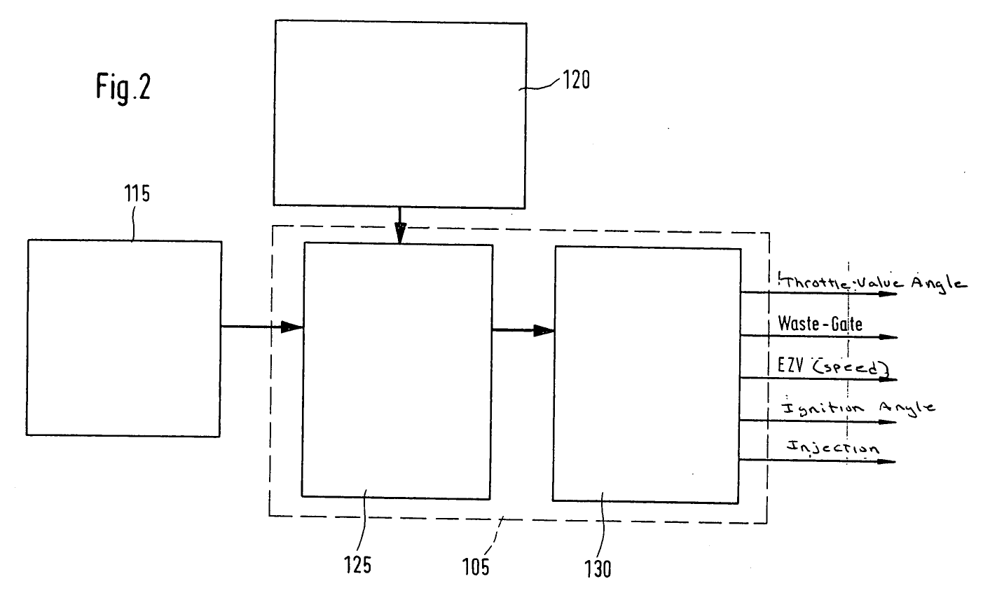

FIG. 2 shows a function chart which describes the conversion of demands on an output variable of the internal combustion engine and on the efficiency of the internal combustion engine into at least one manipulated variable. This conversion takes place in engine management 105. For this purpose, engine management 105 includes a coordinator 125 for coordinating the various demands on the output variable and the efficiency of the internal combustion engine. Engine management 105 also includes a converter 130 which, as a function of the coordination of demands carried out by coordinator 125, sets the at least one manipulated variable for converting the coordinated demands.

In the following, it is assumed by way of example that the output variable of the internal combustion engine is a torque, e.g. an engine torque. Alternatively, the output variable may also be the power output of the internal combustion engine or a variable derived from the torque or from the power output.

In FIG. 2, 115 now designates various torque demands supplied to coordinator 125. These torque demands may be a driver's desired torque as a function of the position of accelerator pedal 110, a torque demand of a traction control system, of an antilock braking system, of a cruise control, of a surge-damping function, etc. In FIG. 2, 120 designates efficiency demands on internal combustion engine 1 that may come, for example, from an idle-speed control, from a starter or from a catalytic-converter heating function. For example, in the case of the catalytic-converter heating function, a deterioration in the efficiency of internal combustion engine 1 is required in order to permit the fastest possible temperature rise of exhaust-gas treatment device 10, 70. Efficiency demands 120 are likewise supplied to coordinator 125.

From the supplied torque demands and efficiency demands on internal combustion engine 1, coordinator 125 ascertains a resulting engine torque to be converted as well as the at least one manipulated variable to be used for the conversion, and passes this information on to converter 130. Converter 130 then forms the at least one manipulated variable in such a way that the engine torque predefined by the coordinator may be converted. According to the example in FIG. 2, the following manipulated variables may be suitably set by converter 130: Throttle-valve angle α_{DK}, the position of waste gate 60, speed n of electric auxiliary air compressor 5, shortened to EZV in FIG. 2, ignition angle α_{2W} and the injection of fuel in the form of the start of injection and the injection duration. Waste gate 60 may be designed in a manner familiar to one skilled in the art, for example, in the form of a valve having a controllable opening cross-section.

According to the exemplary embodiment and/or exemplary method of the present invention, the electric auxiliary air compressor 5 is activated during a starting process of internal combustion engine 1. For example, electric auxiliary air compressor 5 may be activated with the start of internal combustion engine 1, and thus essentially at the same time as internal combustion engine 1. Alternatively, however, electric auxiliary air compressor 5 may first be activated a predefined time after the start of internal combustion engine 1. This time may be suitably established in the application to, for example, prevent electric auxiliary air compressor 5 from placing a strain on the vehicle electrical system directly during the start of internal combustion engine 1 on the one hand, and on the other hand, to still ensure activation of electric auxiliary air compressor 5 before the speed of combustion engine 50 of internal combustion engine 1 is revved up.

After the start of internal combustion engine 1, as a rule the temperature in the region of exhaust-gas treatment device 10, 70 in exhaust branch 55 is less than the operating temperature of exhaust-gas treatment device 10, 70, thus the operating temperature of main catalytic converter 10 and of primary catalytic converter 70. Therefore, until reaching its operating temperature, exhaust-gas treatment device 10, 70 is not fully operative, and consequently is not able to reduce the emissions to the desired value. In this context, exhaust-gas treatment device 10, 70 may be formed only by main catalytic converter 10. Moreover, main catalytic converter 10 and primary catalytic converter 70 may have different operating temperatures; however, after the start of internal combustion engine 1, as a rule, initially neither of the two catalytic converters 10, 70 reaches its operating temperature.

The temperature in exhaust branch 55 may be ascertained by temperature sensor 65. For the sake of simplicity, it shall be assumed in the following that exhaust-gas treatment device 10, 70 has a uniform predefined operating temperature. It is stored in engine management 105 or in a memory assigned to engine management 105. Engine management 105 compares the temperature measured by temperature sensor 65 to the predefined operating temperature. If the measured temperature is below the predefined operating temperature, then, in the event internal combustion engine 1 is started, exhaust-gas treatment device 10, 70 is in a heat-up phase. In this context, it may now be provided that engine management 105 only activates electric auxiliary air compressor 5 when exhaust-gas treatment device 10, 70 is in the heat-up phase, thus the temperature measured by temperature sensor 65 is less than the predefined operating temperature of exhaust-gas treatment device 10, 70.

If main catalytic converter 10 and primary catalytic converter 70 have different predefined operating temperatures, then engine management 105 detects the heat-up phase of exhaust-gas treatment device 10, 70 when at least one of the two predefined operating temperatures is above the temperature measured by temperature sensor 65. In this case, both predefined operating temperatures are stored in engine management 105 or in the memory assigned to engine management 105.

The electric auxiliary air compressor 5 may be triggered as a function of a power necessary for setting the predefined operating temperature of exhaust-gas treatment device 10, 70. The triggering is carried out or performed in such a way that engine management 105 triggers electric motor 90 for setting a higher speed when a greater heating power is necessary, and engine management 105 triggers electric motor 90 for setting a lower speed when the required heating power is less. When a predefined quantity of heat has been delivered to exhaust-gas treatment device 10, 70, then engine management 105 may also deactivate the electric auxiliary air compressor again. Engine management 105 recognizes the delivery of the predefined quantity of heat to exhaust-gas treatment device 10, 70 from the fact that, for example, the temperature measured by temperature sensor 65 has reached the predefined operating temperature of exhaust-gas treatment device 10, 70.

To heat up exhaust-gas treatment device 10, 70, it is necessary to increase the exhaust-gas enthalpy flow in exhaust branch 55. This is accomplished in that, during the heat-up phase of exhaust-gas treatment device 10, 70 during a starting process of internal combustion engine 1, a catalytic-converter heating function of engine management 105 demands a corresponding deterioration in the mechanical efficiency of combustion engine 50 from coordinator 125. At least one of efficiency demands 120 may thus likewise be integrated in engine management 105, for example, the catalytic-converter heating function. For instance, this required efficiency deterioration is converted by converter 130 in accordance with a specification of coordinator 125, by retarding the ignition angle.

If the intention is to maintain the engine torque to be delivered by combustion engine 50 unchanged, then it is necessary to increase the air-mass flow supplied to combustion engine 50. This may be accomplished by suitable triggering of throttle valve 30 in the form of opening it further. In addition, depending upon fuel injector 35, 40 used, engine management 105 is able to increase the injection quantity by suitable triggering of this fuel injector, in that the start of injection and the injection duration are adjusted accordingly. Thus, coordinator 125 predefines to converter 130 the opening of throttle valve 30 and the injection quantity as further manipulated variables to be used for the conversion of the unaltered engine torque. In this way, given essentially unaltered engine torque, the exhaust-gas-mass flow and the exhaust-gas temperature may be increased, and therefore the exhaust-gas enthalpy flow may be increased. The result is that exhaust-gas treatment device 10, 70 heats up more quickly.

In addition, in the case described, coordinator 125 is also able to specify the activation of electric auxiliary air compressor 5, i.e. the control of its speed as a manipulated variable to be used. By activating electric auxiliary air compressor 5 during the heat-up phase of exhaust-gas treatment device 10, 70, the air-mass flow to be supplied to combustion engine 50 may be increased even further, and therefore the moment of ignition may be even further retarded in order to maintain an essentially unaltered engine torque. The supercharging of electric auxiliary air compressor 5 consequently yields a further increase in the exhaust-gas enthalpy flow, and therefore an additional acceleration of the temperature rise of exhaust-gas treatment device 10, 70. The result is that the pollutant emissions of combustion engine 50 are markedly reduced during the warm-up phase.

Without an air compressor in air feed 20, for the air charge of the cylinders of combustion engine 50 and thus for the exhaust-gas enthalpy flow, one is restricted to the maximum pressure arising in intake manifold 25 in the amount, for instance, of the ambient pressure. Since electric auxiliary air compressor 5 may be activated independently of the exhaust-gas-mass flow in exhaust branch 55 immediately after the start or still during the start of internal combustion engine 1, exhaust-gas treatment device 10, 70 may be heated particularly quickly. This brings an additional advantage compared to an air compressor concept without electric auxiliary air compressor 5.

Namely, for its activation, exhaust-gas turbocharger 15 already demands a certain exhaust-gas-mass flow that is not available immediately after the start or still during the start of internal combustion engine 1. The equivalent holds true if, instead of exhaust-gas turbocharger 15, a supercharger is used which also at first demands a corresponding mechanical energy at the crankshaft that is not available immediately after the start or still during the start of internal combustion engine 1.

Additionally, however, a further increase of the charge and therefore a further timing retard of the ignition angle may be implemented if a positive-feedback effect is present between electric auxiliary air compressor 5 and exhaust-gas turbocharger 15 or, alternatively, the supercharger. Due to the increase in charge triggered by electric auxiliary air compressor 5, the exhaust-gas-mass flow is formed earlier and increases more rapidly, so that exhaust-gas turbocharger 15 also responds earlier and supports electric auxiliary air compressor 5 in increasing the charge. Therefore, given suitable fuel metering, the exhaust-gas enthalpy flow may be further increased, and the temperature rise of exhaust-gas treatment device 10, 70 may be further accelerated.

Although turbine 75 of exhaust-gas turbocharger 15 withdraws heat from the exhaust-gas-mass flow, given suitable fuel metering through fuel injector 35, 40 used, the increase in the exhaust-gas enthalpy flow achieved by additionally attainable air charge in the combustion chamber of combustion engine 50 is greater than the heat withdrawal by turbine 75.

Because of the very sharply increased exhaust-gas-mass flow due to the late initiation of the combustion process based on the retard of the moment of ignition, anyway in relation to the mechanical power output by combustion engine 50 or the output engine torque, conditions which allow exhaust-gas treatment device 10, 70 to be heated rapidly therefore also exist for the case of the additional supercharging by exhaust-gas turbocharger 15.

Due to the timing retard of the moment of ignition, the combustion begins markedly after reaching the top dead center of the piston of combustion engine 50. The equivalent holds true when using a supercharger in addition to or as an alternative to exhaust-gas turbocharger 15. It may be particularly advantageous to use the exemplary method of the present invention for a gasoline engine with direct gasoline injection, thus using first fuel injector 35, since, for example, in the case of a split injection in so-called homogeneous-split operation, extremely late moments of ignition are possible. They may be on the order of approximately 35° after the top dead center of the piston.

During homogeneous-split operation, at least two injections of first fuel injector 35 are provided for one combustion process. The first injection takes place during the induction stroke, in order to form a homogeneous mixture in the combustion chamber of combustion engine 50. This first injection leads to a lean homogeneous air/fuel mixture in the combustion chamber of combustion engine 50. Subsequently, a second injection takes place during a compression of the air/fuel mixture in the combustion chamber of combustion engine 50. This second injection takes place locally in the region of spark plug 45, and results in a rich air/fuel mixture in the region of spark plug 45. Ignition performance when igniting the air/fuel mixture is thereby increased, and a rapid burn-through of the air/fuel mixture is achieved in the combustion chamber of combustion engine 50.

If the moment of ignition to take place on the order of approximately 35° after the top dead center of the piston, then the utilization of electric auxiliary air compressor 5 and optionally exhaust-gas turbocharger 15 and/or the supercharger to increase the heat flow in exhaust branch 55 when heating exhaust-gas treatment device 10, 70 may be particularly useful, since, for example, at an idling operating point of internal combustion engine 1, the high air-mass flow may be used in intake manifold 25. Since at the idling operating point, only a comparatively low drive power or comparatively low engine torque and therefore a comparatively low air-mass flow in intake manifold 25 are necessary, the air-mass flow available in intake manifold 25 may be used to a particularly large extent for increasing the exhaust-gas enthalpy flow, and therefore for heating up exhaust-gas treatment device 10, 70.

The case when the injection is not carried out by first fuel injector 35, but rather by second fuel injector 40, is a multipoint injection. In this case, it is necessary to ensure the late-ignition compatibility of combustion engine 50 by additional measures, in order to ensure the desired increase in the rate of heat flow in exhaust branch 55 for heating exhaust-gas treatment device 10, 70. Such measures may be achieved, for example, by inducing a suitable charge movement in intake manifold 25, and therefore in the combustion chamber of combustion engine 50. In the case of a multipoint injection by second fuel injector 40, the mixture formation takes place in intake manifold 25. In this way, a homogeneous air/fuel mixture is already adjusted in intake manifold 25, and goes from intake manifold 25 via the intake valve into the combustion chamber of combustion engine 50.

To still permit good burn-through of the air/fuel mixture in the combustion chamber of combustion engine 50, even in the case of a retarded ignition angle, a suitable charge movement is necessary in intake manifold 25 and therefore also in the combustion chamber of combustion engine 50, which is realized optionally by the activation of electric auxiliary air compressor 5, and possibly additionally exhaust-gas turbocharger 15 and/or the supercharger. Thus, electric auxiliary air compressor 5 and possibly exhaust-gas turbocharger 15 and/or the supercharger, through the charge movement generated, permit, first of all, a corresponding retard of the ignition angle, and on the other hand, make available the air-mass flow in air feed 20 necessary for increasing the exhaust-gas enthalpy flow, and therefore the necessary charge in the combustion chamber of combustion engine 50.

For all the examples described, engine management 105 shifts the ignition angle as much as possible or useful in the “retard” direction. In this context, the exhaust-gas enthalpy flow is tied to the air-mass flow available via intake manifold 25 for combustion engine 50. In turn, the maximum possible air-mass flow to be set depends, in a manner familiar to one skilled in the art, on the maximum possible intake-manifold pressure, which corresponds to the ambient pressure in concepts without air compressor. By increasing the intake-manifold pressure with the aid of electric auxiliary air compressor 5 and possibly exhaust-gas turbocharger 15 and/or the supercharger, the timing retard of the ignition angle, and therefore the possible exhaust-gas enthalpy flow may be expanded in the manner described. At the same time, provision may be made to take into account a portion of the ignition-angle retard as a torque reserve for ensuring a satisfactory quality in an idling operating state. The ignition angle retard is then no longer not only used for increasing the exhaust-gas enthalpy flow, but also for forming a torque reserve for the idling operating state.

As described, in conventional supercharger concepts, exhaust-gas turbocharger 15 represents a heat sink, which after the start of internal combustion engine 1, has a disadvantageous effect on the heat-up behavior of exhaust-gas treatment device 10, 70. In contrast to a conventional supercharger concept with exhaust-gas turbocharger, the use of electric auxiliary air compressor 5 allows for increasing the intake-manifold pressure as well, without turbine 75 of exhaust-gas turbocharger 15 being driven. This may be achieved, for example, by bypassing turbine 75 for a predefined time through waste gate 60. This predefined time may be selected so that it does not exceed the operation duration of electric auxiliary air compressor 5 during the heat-up phase of exhaust-gas treatment device 10, 70, but rather is less than or equal to the duration of this heat-up phase.

The smaller this predefined time is selected to be, however, the more exhaust-gas turbocharger 15 is also able to contribute to the temperature rise of exhaust-gas treatment device 10, 70 based on the positive-feedback effect described, suitable fuel metering being of decisive importance to prevent exhaust-gas turbocharger 15 from withdrawing more heat from the exhaust-gas-mass flow than it is able to generate based on second air compressor 85 in exhaust branch 55. Moreover, provision may even be made to at least partially deactivate electric auxiliary air compressor 5 when exhaust-gas turbocharger 15 is used, which is detected by speed sensor 135 in engine management 105. For example, by suitable triggering of electric motor 90, engine management 105 is able to reduce the speed of electric auxiliary air compressor 5 to the extent to which the speed of second air compressor 85, detected by speed sensor 135, increases. This ensures, on the one hand, a rapid temperature rise of exhaust-gas treatment device 10, 70, and on the other hand, the lowest possible strain on the vehicle electrical system by electric auxiliary air compressor 5.

The buildup of the additional intake-manifold pressure by first air compressor 100 and optionally second air compressor 85 may be regulated or also pre-controlled, for example, by engine management 105 in accordance with the engine torque to be converted and called for by coordinator 125 on one hand, and the requirement of heating power for exhaust-gas treatment device 10, 70 as a function of the temperature measured by temperature sensor 65 on the other hand, using the manipulated variables described. With the retarded ignition angle, the excess air charge in the combustion chamber of combustion engine 50 not existing for forming the required engine torque is converted into exhaust-gas enthalpy which, as described, may be used for heating up exhaust-gas treatment device 10, 70.

If the quantity of heat necessary for heating up exhaust-gas treatment device 10, 70 has been fed into exhaust-gas treatment device 10, 70, then electric auxiliary air compressor 5 is deactivated by engine management 105. The input of the necessary quantity of heat, by achieving the operating temperature in exhaust branch 55, may be derived from the measured value of temperature sensor 65 in engine management 105. If, in addition to electric auxiliary air compressor 5, exhaust-gas turbocharger 15 is also activated, thus, for example, waste gate 60 is closed, then electric auxiliary air compressor 5 may be limited (or regulated down) by engine management 105, for instance, to the degree to which the intake-manifold pressure necessary for generating the heating power required for heating up exhaust-gas treatment device 10, 70 is generated by second air compressor 85.

To that end, for example, engine management 105 is able to evaluate the time characteristic of the temperature in exhaust branch 55 measured by temperature sensor 65. As soon as the time gradient of this temperature characteristic exceeds a first predefined limiting value, engine management 105 is able to limit electric auxiliary air compressor 5 accordingly and reduce its speed, in order to bring the time gradient of the temperature characteristic below the first predefined limiting value again. In this way, given a suitable stipulation of this first limiting value, a rapid temperature rise of exhaust-gas treatment device 10, 70 on one hand, and on the other hand, the lowest possible strain on the vehicle electrical system by electric auxiliary air compressor 5 may be achieved.

A joint, simultaneous, combined use of electric auxiliary air compressor 5 and exhaust-gas turbocharger 15 may be provided when the pressure drop via turbine 75 of exhaust-gas turbocharger 15 permits it, and the opening angle of waste gate 60 is suitably small. If, assuming joint operation with exhaust-gas turbocharger 15, electric auxiliary air compressor 5 is completely deactivated during the heat-up phase of exhaust-gas treatment device 10, 70, then exhaust-gas turbocharger 15 must subsequently ensure the temperature rise of exhaust-gas treatment device 10, 70 to the predefined operating temperature. Here as well, engine management 105 must trigger waste gate 60 in such a way that a sufficient pressure drop is present at turbine 75 in order to produce the heating power required.

For triggering electric auxiliary air compressor 5 and exhaust-gas turbocharger 15, a second predefined limiting value may be provided for the time gradient of the temperature characteristic of the temperature measured by temperature sensor 65 which is smaller than the first predefined limiting value. In this case, engine management 105 sets the speed of electric auxiliary air compressor 5 in such a way that the temperature measured by temperature sensor 65 has in its time characteristic, a gradient which exceeds the second predefined limiting value. If the heating power for heating up exhaust-gas treatment device 10, 70 is set both by activation of the electric auxiliary air compressor and with the aid of exhaust-gas turbocharger 15, then engine management 105 must control both the speed of electric auxiliary air compressor 5 and the opening of waste gate 60 in such a way that the time gradient of the temperature characteristic of the temperature measured by temperature sensor 65 is above the second predefined limiting value.

If, in this context, electric auxiliary air compressor 5 is limited, then engine management 105 must control waste gate 60 in such a way that the second predefined limiting value is exceeded by the time gradient of the temperature characteristic of the temperature measured by temperature sensor 65. If the first predefined limiting value is exceeded by the time gradient of the temperature characteristic, then this is possibly critical only in view of the strain on the vehicle electrical system by electric auxiliary air compressor 5, and may be prevented by suitable reduction of the speed of electric auxiliary air compressor 5 on the part of engine management 105, provided electric auxiliary air compressor 5 is even activated and the intake-manifold pressure is not already generated solely by exhaust-gas turbocharger 15, which does not strain the vehicle electrical system.

Depending on the load demanded or the operating point of internal combustion engine 1 demanded, deactivation of electric auxiliary air compressor 5 may even already be demanded before the heat-up phase of exhaust-gas treatment device 10, 70 has ended. This could be the case, for example, for a full-load demand immediately after the start of internal combustion engine 1. Such a full-load demand results, for example, when the vehicle pulls out from a service area onto the expressway. In this case, the conversion of the full-load demand is more important, because it may be critical with regard to safety for the vehicle performance, so that in this case, it may not be possible to make sufficient energy available for heating up exhaust-gas treatment device 10, 70. Engine management 105 is able to detect the full-load demand from the position of accelerator pedal 110, for instance, this full-load demand being supplied as one of torque demands 115 to coordinator 125. It induces converter 130 to a corresponding conversion of the demanded torque, without it allowing a retard of the ignition angle and an activation of electric auxiliary air compressor 5 for an accelerated temperature rise of exhaust-gas treatment device 10, 70.

In this context, the full-load demand represents an operating point of internal combustion engine 1 at which the conversion of the driver's request has priority over a rapid temperature rise of exhaust-gas treatment device 10, 70.

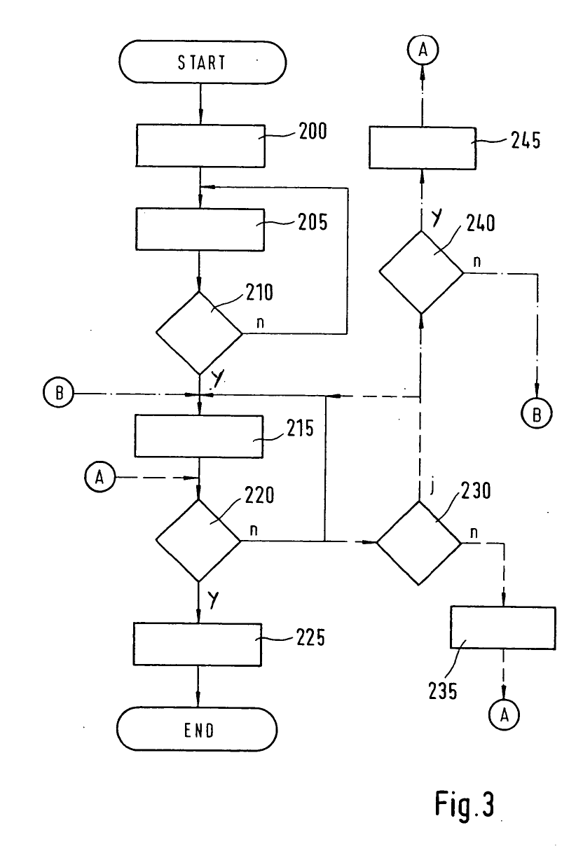

FIG. 3 now shows a flowchart for an exemplary sequence of the exemplary method according to the present invention. After the start of the program, at a program point 200, internal combustion engine 1 is started, for example, by activation of an engine starter. Electric auxiliary air compressor 5 may be activated by engine management 105 with the start of internal combustion engine 1. In this exemplary embodiment, it is assumed by way of example that electric auxiliary air compressor 5 is first activated after the start of the engine starter. For this case, electric auxiliary air compressor 5 is not activated at program point 200, but rather, in a first specific embodiment described, a timing element is started by engine management 105. The time constant of this timing element corresponds to the predefined time established in the application which, as described, may be selected in such a way that it still expires prior to the revving-up of combustion engine 50. After program point 200, the program branches to a program point 205.

At program point 205, there is a wait for a predefined period of time. Subsequently, the program branches to a program point 210. At program point 210, engine management 105 checks whether, after being set at program point 200, the timing element was set back again, that is, whether the applied predefined time has expired. If this is the case, the program branches to a program point 215, otherwise the program branches back to program point 205.

At program point 215, engine management 105 induces activation of electric auxiliary air compressor 5, retard of the ignition angle, triggering of throttle valve 30 to increase the air-mass flow in air feed 20, and triggering of the fuel injector utilized for the injection of the fuel mass, corresponding to the increased air-mass flow, for attaining the desired exhaust-gas enthalpy flow. Electric auxiliary air compressor 5 is activated, for example, by setting a predefined starting speed established in the application. Engine management 105 also triggers waste gate 60 in such a way that it is completely closed and therefore the exhaust-gas-mass flow is completely conducted via turbine 75. Subsequently, the program branches to a program point 220.

At program point 220, engine management 105 checks whether the temperature measured by temperature sensor 65 has reached the predefined operating temperature of exhaust-gas treatment device 10, 70. If this is the case, the program branches to a program point 225; otherwise there is a return to program point 215 and the setting of the utilized manipulated variables described for program point 215 is maintained. At program point 225, engine management 105 deactivates electric auxiliary air compressor 5. The program is subsequently exited.

If it was established at program point 220 that the predefined operating temperature of exhaust-gas treatment device 10, 70 was not yet reached, then in a further query step 230, engine management 105 is able to check whether the time gradient of the temperature characteristic exceeds the predefined second limiting value.

If this is the case, there is a return to program point 215 and the manipulated-variable settings are maintained. Otherwise, the program branches to a program point 235, and the speed of electric auxiliary air compressor 5 is increased in order to permit the time gradient of the temperature characteristic to exceed the second predefined limiting value. The program subsequently branches to program point 220. The alternative described is represented with dotted lines in FIG. 3.

In addition, at program point 220, engine management 105 is able to check whether there is a full-load demand. If this is the case, the program branches to program point 225; otherwise the check already described as to whether the temperature measured by temperature sensor 65 has reached the predefined operating temperature of exhaust-gas treatment device 10, 70 is carried out, the program branching to program point 225 if this is the case, and to program point 215 or, in the alternative specific embodiment, to program point 230 if this is not the case.

In the event that waste gate 60, as described, is closed, and therefore both electric auxiliary air compressor 5 and exhaust-gas turbocharger 15 are activated for heating up exhaust-gas treatment device 10, 70 during the heat-up phase and during the starting process of internal combustion engine 1, upon reaching the predefined operating temperature of exhaust-gas treatment device 10, 70, at program point 225, waste gate 60 is also opened in order to switch off exhaust-gas turbocharger 15. It is only switched on again when a suitable acceleration demand or a suitable request for torque is received from accelerator pedal 110 at engine management 105.

In another alternative exemplary embodiment, in the case of the yes-branching from program point 230, instead of branching to program point 215, program point 240 (which is indicated in FIG. 3 by a dot-dash line) may be branched to. At program point 240, engine management 105 then checks whether the first predefined limiting value is exceeded by the time gradient of the temperature characteristic. If this is the case, the program branches to a program point 245, otherwise the program branches back to program point 215, and the set manipulated variables are not changed. At program point 245, engine management 105 reduces the speed of electric auxiliary air compressor 5, with the aim that the time gradient of the temperature characteristic drop below the first predefined limiting value again.

The exceeding of the first upper limiting value, as described, may therefore stem from the fact that both electric auxiliary air compressor 5 and exhaust-gas turbocharger 15 are activated. However, this exceeding may also result when electric auxiliary air compressor 5 is operated alone. After program point 245, the program branches to program point 220. In an alternative to FIG. 3, waste gate 60 may be completely opened at program point 215, to prevent operation of exhaust-gas turbocharger 15 during the heat-up phase of exhaust-gas treatment device 10, 70.

In another exemplary embodiment, the timing element described need not be provided and it need not be started at program point 200. Alternatively, at program point 205, the temperature is measured by temperature sensor 65 and forwarded to engine management 105. At subsequent program point 210, engine management 105 then checks whether the measured temperature is less than the predefined operating temperature of exhaust-gas treatment device 10, 70. If this is the case, the program branches to program point 215, otherwise the program branches back to program point 205. The remaining program points remain unchanged.

1. A method for operating an internal combustion engine using an electrically operated air compressor, the method comprising:
activating the electrically operated air compressor during a starting process of the internal combustion engine.

2. The method of claim 1, wherein the electrically operated air compressor is activated with the start of the internal combustion engine.

3. The method of claim 1, wherein the electrically operated air compressor is activated a predefined time after the start of the internal combustion engine.

4. The method of claim 1, wherein the electrically operated air compressor is activated prior to a rev-up of the internal combustion engine.

5. The method of claim 1, wherein the electrically operated air compressor is activated during a heat-up phase of an exhaust-gas treatment device, which is a catalytic converter.

6. The method of claim 5, wherein the electrically operated air compressor is triggered as a function of a heating power necessary for setting a predefined operating temperature of the exhaust-gas treatment device.

7. The method of claim 6, wherein the electrically operated air compressor is deactivated when a predefined quantity of heat has been delivered to the exhaust-gas treatment device.

8. The method of claim 1, wherein the electrically operated air compressor is operated with at least one further air compressor.

9. The method of claim 8, wherein the electrically operated air compressor is at least partially deactivated when the further air compressor is used.

10. The method of claim 1, wherein a direct fuel injection is performed.

11. The method of claim 10, wherein the fuel is at least partially injected during a compression phase.

12. The method of claim 1, wherein the electrically operated air compressor is deactivated as a function of a required load or a required operating point.

13. The method of claim 8, wherein the at least one further air compressor includes an exhaust-gas turbocharger.

14. The method of claim 13, wherein the at least one further air compressor is arranged in a positive feedback arrangement.

15. The method of claim 10, wherein the fuel is at least partially injected during a compression phase according to a homogenous-split operation.
